(19) United States
(12) Patent Application Publication
(10) Pub. No.: US 2017/0046768 A1
(43) Pub. Date: Feb. 16, 2017

(54) HYBRID RECOMMENDATION SYSTEM FOR RECOMMENDING PRODUCT ADVERTISEMENTS

(71) Applicant: SVG Media Pvt Ltd, New Delhi (IN)

(72) Inventors: Prabha KUMARI, Gurgaon (IN); Udit SARIN, Gurgaon (IN)

(21) Appl. No.: 14/945,317

(22) Filed: Nov. 18, 2015

(30) Foreign Application Priority Data
Aug. 10, 2015 (IN) 2448/DEL/2015

(51) Int. Cl. G06Q 30/06; H04L 29/08

(52) U.S. Cl. CPC G06Q 30/0631; H04L 67/22

(57) ABSTRACT

The present disclosure provides a method and system for hybrid recommendation of one or more products through one or more advertisements. The method collects a first set of pre-defined attributes associated with a user of one or more users. In addition, the method classifies the user of the one or more users in one or more clusters based on the first set of pre-defined attributes. Moreover, the method determines one or more characteristics associated with a product of one or more products currently viewed by the user. Further, the method gathers data associated with other one or more products similar to the determined product. Furthermore, the method computes a weighted average propensity to buy for the user. In addition, the method recommends the one or more advertisements associated with the product of the one or more products currently viewed by the user and the other one or more products.

### TECHNICAL FIELD

The present disclosure relates to the field of electronic advertising. More specifically, the present disclosure relates to an automatic recommendation of product related advertisements based on an aggregate of behavioral characteristics.

### BACKGROUND

With the advent of technological advancements in the last few years, online advertising has evolved into a topmost advertising medium. Nowadays, a substantial amount of users spend their time browsing through the internet for viewing numerous products of their choice on various online publishers. For example, a user may be looking for a new smart phone or another user may be interested in buying footwear or apparels. Also, these online publishers employ various technologies to gain access to a wide range of information available from these users who access their online portals.

In the current scenario, this information is being utilized for advertising purposes and targeting users who are looking for one or more specific products on various publisher websites. This information is crucial for running the advertising business effectively. Moreover, the tendency of the users to consistently indulge in the internet has been leveraged by advertisers and publishers for effectively serving advertisements to the users for generating and sharing revenue between each other.

Traditionally, various recommendation systems are being utilized by the online publishers for effective targeting of the users for serving accurate advertisements. These recommendation systems are capable of targeting the users for showing advertisements related to the products of the interests of the users. Further, each user is looking for a different type of attributes in a product while browsing on the publisher website. For example, a user may give higher weightage to a processor speed and RAM while searching for mobile phones or another user may give higher weightage to size and color while searching for mobile phones. The current recommendation systems utilize this information and recommend one or more products having similar attributes to the products of interest of the users. Also, these recommendation systems improve an overall online experience for the users and help the one or more publishers in gaining valuable insight regarding the preferences of the users.

Going further, these recommendation systems record the response of the users based on interaction with the one or more recommended advertisements. Moreover, the recommendation systems record the one or more actions taken by one or more users for a particular product over a period of time. In addition, the recommendation systems calculate a probability of the users for buying the one or more products. The one or more users are divided based on their interests in the one or more products. Further, the interests of the one or more users keep changing over the period of time. In addition, some of the recommendation systems perform clustering of the one or more users for effective targeting.

Moreover, the recommendation systems presently known in the art are build using either user based collaborative recommendation, item based recommendation, content based recommendation and demography based recommendation. Some of the hybrid recommendation systems have been built using a combination of content and user based collaborative recommendation algorithm. Several present systems are known in the art which divides the users in one or more clusters. One such system employs a clustering process for creating clusters of user using a distance metric. Another such system allows the classifying of the users based on one or more user characteristics. Yet another system allows the recommendation of the products from a population of one or more products based on intelligence contained in processing elements. This system takes into account subjective and/or objective product information received from consumers or inputs to the systems as part of the initial setup. Yet another system recommends one or more items by fetching ratings provided to the items by various users and calculating a preference score based on the item ratings.

However, the present hybrid recommendation systems known in the art do not allow the clustering of the users based on calculation of an average cluster centroid. In addition, the present hybrid recommendation systems do not allow recommendation of one or more products similar to the product currently viewed by the user based on calculation of the average cluster centroid. Moreover, the present hybrid recommendation systems do not allow computation of propensity to buy the product for the user based on past interaction of the one or more users with the product. Further, the present hybrid recommendation systems do not recommend the product through the advertisements based on the propensity to buy. Furthermore, the present hybrid recommendation systems do not allow deciding of the advertiser of one or more advertisers whose recommended product will be displayed to the user. Moreover, there is no such system known in the art which utilizes a combination of a user based model, an item based model, a content based model and a demography based model.

In the light of the above stated discussion, there is a need for system that overcomes the above stated disadvantages.

### SUMMARY

In an aspect of the present disclosure, the present disclosure provides a computer-implemented method. The computer-implemented method performs hybrid recommendation of one or more products viewed by a user of one or more users on a publisher of one or more publishers through one or more advertisements. The computer-implemented method collects a first set of pre-defined attributes associated with the user of the one or more users viewing the one or more products on the publisher of the one or more publishers with a processor. In addition, the computer-implemented method classifies the user of the one or more users in one or more clusters based on the first set of pre-defined attributes with the processor. Moreover, the computer-implemented method determines one or more characteristics associated with a product of the one or more products currently viewed by the user of the one or more users with the processor. Further, the computer-implemented method gathers data associated with other one or more products similar to the product currently viewed by the user with the processor. Also, the data is gathered based on the determination of the one or more characteristics and the identification of the cluster of the one or more clusters. Furthermore, the computer-implemented method computes a weighted average propensity to buy for the user of the one or more users with the processor. In addition, the computer-implemented method recommends the one or more advertisements associated with the product of the one or more products currently viewed by the user and the other one or more products with the processor. The other one or more products have a highest weighted average propensity to buy. The one or more clusters are created based on a first set of parameters. In addition, the classification and clustering is done to identify a cluster of the one or more clusters to which the user of the one or more users belongs. Also, the identification is based on calculation of an average cluster centroid value for the user of the one or more users. The one or more clusters are created for identification of one or more parameters for the clustering. The clustering is done at pre-defined intervals of time. The determination of the one or more characteristics is based on the identification of the cluster of the one or more clusters. The other one or more products depict similar characteristics to the one or more characteristics associated with the product of the one or more products currently viewed by the user. In addition, the other one or more products belong to an identified cluster of the one or more clusters corresponding to the product of the one or more products currently viewed by the user. Further, the weighted average propensity to buy is computed for the product of the one or more products currently viewed by the user of the one or more users and the other one or more products similar to the product currently viewed by the user. The weighted average propensity to buy is computed based on a second set of pre-defined attributes and a pre-defined criterion. The pre-defined criterion is based on analysis of a past behavior of a set of users of the one or more users who have bought the product of the one or more products and the other one or more products. In addition, the pre-defined criterion is based on one or more actions taken corresponding to the product of the one or more products and the other one or more products.

In an embodiment of the present disclosure, the computer-implemented method further calculates a recommendation score for the product of the one or more products currently viewed by the user of the one or more users and the other one or more products with the processor. The recommendation score is calculated based on multiplication of a similarity of the product currently viewed by the user and the other one or more products and the corresponding weighted average propensity to buy for the product currently viewed by the user and the other one or more products.

In another embodiment of the present disclosure, the recommendation is based on at least one of a seller rating, a price of the product of the one or more products and the other one or more products recommended to the user. Also, the recommendation is based on a click through rate and a seller bid for a particular ad format and publisher combination.

In an embodiment of the present disclosure, the first set of pre-defined attributes includes intent of the user, the one or more products liked by the user, the one or more products disliked by the user and age of the user. Moreover, the first set of pre-defined attributes includes gender of the user, current location of the user, a type of device utilized by the user, current contextual behavior of the user and past behavior of the user.

In an embodiment of the present disclosure, the first set of parameters includes a demography of the user, one or more details associated with the product of the one or more products and one or more attributes associated with the product of the one or more products.

In an embodiment of the present disclosure, the second set of pre-defined attributes corresponds to one or more types of events. The one or more types of events include duration of view by the user and the set of users for the product of the one or more products and the other one or more products. In addition, the one or more types of events include search performed by the user and the set of users for searching the product of the one or more products and the other one or more products. Further, the one or more types of events include add to cart event, add to wish list event, a purchase event, checkout initiated event, product view and product reject event.

In another embodiment of the present disclosure, the computer-implemented method further assigns a value corresponding to each of the one or more types of events for the user and the set of users with the processor. The value is assigned to determine a propensity to buy for the product of the one or more products currently viewed by the user and the other one or more products. The value is highest for the purchase event and the value is lowest for the product reject event.

In an embodiment of the present disclosure, the one or more characteristics associated with the product of the one or more products includes of a type of the product viewed, a category of the product viewed and a name of the product viewed. The one or more characteristics include an id of the product viewed, a brand name of the product viewed and one or more specifications of the product viewed by the user.

In an embodiment of the present disclosure, the computer-implemented method further comprising updates the weighted average propensity to buy, the one or more clusters and the first set of pre-defined attributes with the processor. In addition, the computer-implemented method further updates the first set of parameters, the second set of pre-defined attributes and the recommendation score. The updation is performed at pre-defined continuous intervals of time. The updation is done for refining of recommendation algorithm.

In an embodiment of the present disclosure, the computer-implemented method further takes a decision associated with an advertiser of one or more advertisers whose advertisement of the plurality of advertisements will be displayed. Moreover, the advertisement corresponds to the recommended product of the one or more products and the other one or more products. The decision is taken based on a condition specified by the publisher of the one or more publishers.

In another aspect of the present disclosure, the present disclosure provides a computer-program product. The computer-program product performs hybrid recommendation of one or more products viewed by a user of one or more users on a publisher of one or more publishers through one or more advertisements. The computer-program product includes a computer readable storage medium. The computer readable storage medium has a computer program stored thereon. The computer-program product collects a first set of pre-defined attributes associated with the user of the one or more users viewing the one or more products on the publisher of the one or more publishers. In addition, the computer-program product classifies the user of the one or more users in one or more clusters based on the first set of pre-defined attributes. Moreover, the computer-program product determines one or more characteristics associated with a product of the one or more products currently viewed by the user of the one or more users. Further, the computer-program product method gathers data associated with other one or more products similar to the product currently viewed by the user. Also, the data is gathered based on the determination of the one or more characteristics and the identification of the cluster of the one or more clusters. Furthermore, the computer-program product computes a weighted average propensity to buy for the user of the one or more users. In addition, the computer-program product recommends the one or more advertisements associated with the product of the one or more products currently viewed by the user and the other one or more products. The other one or more products have a highest weighted average propensity to buy. The one or more clusters are created based on a first set of parameters. In addition, the classification and clustering is done to identify a cluster of the one or more clusters to which the user of the one or more users belongs. Also, the identification is based on calculation of an average cluster centroid value for the user of the one or more users. The one or more clusters are created for identification of one or more parameters for the clustering. The clustering is done at pre-defined intervals of time. The determination of the one or more characteristics is based on the identification of the cluster of the one or more clusters. The other one or more products depict similar characteristics to the one or more characteristics associated with the product of the one or more products currently viewed by the user. In addition, the other one or more products belong to an identified cluster of the one or more clusters corresponding to the product of the one or more products currently viewed by the user. Further, the weighted average propensity to buy is computed for the product of the one or more products currently viewed by the user of the one or more users and the other one or more products similar to the product currently viewed by the user. The weighted average propensity to buy is computed based on a second set of pre-defined attributes and a pre-defined criterion. The pre-defined criterion is based on analysis of a past behavior of a set of users of the one or more users who have bought the product of the one or more products and the other one or more products. In addition, the pre-defined criterion is based on one or more actions taken corresponding to the product of the one or more products and the other one or more products.

In an embodiment of the present disclosure, the computer-program product further calculates a recommendation score for the product of the one or more products currently viewed by the user of the one or more users and the other one or more products with the processor. The recommendation score is calculated based on multiplication of a similarity of the product currently viewed by the user and the other one or more products and the corresponding weighted average propensity to buy for the product currently viewed by the user and the other one or more products.

In an embodiment of the present disclosure, the first set of pre-defined attributes includes intent of the user, the one or more products liked by the user, the one or more products disliked by the user and age of the user. Moreover, the first set of pre-defined attributes includes gender of the user, current location of the user, a type of device utilized by the user, current contextual behavior of the user and past behavior of the user.

In yet another aspect of the present disclosure, the present disclosure provides a hybrid recommendation system. The hybrid recommendation system performs hybrid recommendation of one or more products viewed by a user of one or more users on a publisher of one or more publishers through one or more advertisements. The hybrid recommendation system includes a collection module in a processor. The collection module is configured to collect a first set of pre-defined attributes associated with the user of the one or more users viewing the one or more products on the publisher of the one or more publishers. In addition, the hybrid recommendation system includes a clustering module in the processor. The clustering module is configured to classify the user of the one or more users in one or more clusters based on the first set of pre-defined attributes. Moreover, the hybrid recommendation system includes a determination module in the processor. The determination module is configured to determine one or more characteristics associated with a product of the one or more products currently viewed by the user of the one or more users. Further, the hybrid recommendation system includes a gathering module in the processor. The gathering module is configured to gather data associated with other one or more products similar to the product currently viewed by the user. The data is gathered based on the determination of the one or more characteristics and the identification of the cluster of the one or more clusters. Furthermore, the hybrid recommendation system includes a computational module in the processor. The computational module is configured to compute a weighted average propensity to buy for the user of the one or more users. Also, the hybrid recommendation system includes a recommendation engine in the processor. The recommendation engine is configured to recommend the one or more advertisements associated with the product of the one or more products currently viewed by the user and the other one or more products. The other one or more products have a highest weighted average propensity to buy. The one or more clusters are created based on a first set of parameters. In addition, the classification and clustering is done to identify a cluster of the one or more clusters to which the user of the one or more users belongs. Also, the identification is based on calculation of an average cluster centroid value for the user of the one or more users. The one or more clusters are created for identification of one or more parameters for the clustering. The clustering is done at pre-defined intervals of time. The determination of the one or more characteristics is based on the identification of the cluster of the one or more clusters. The other one or more products depict similar characteristics to the one or more characteristics associated with the product of the one or more products currently viewed by the user. In addition, the other one or more products belong to an identified cluster of the one or more clusters corresponding to the product of the one or more products currently viewed by the user. Further, the weighted average propensity to buy is computed for the product of the one or more products currently viewed by the user of the one or more users and the other one or more products similar to the product currently viewed by the user. The weighted average propensity to buy is computed based on a second set of pre-defined attributes and a pre-defined criterion. The pre-defined criterion is based on analysis of a past behavior of a set of users of the one or more users who have bought the product of the one or more products and the other one or more products. In addition, the pre-defined criterion is based on one or more actions taken corresponding to the product of the one or more products and the other one or more products.

In an embodiment of the present disclosure, the hybrid recommendation system further includes a scoring module in the processor. The scoring module is configured to calculate a recommendation score for the product of the one or more products currently viewed by the user of the one or more users and the other one or more products. The recommendation score is calculated based on multiplication of a similarity of the product currently viewed by the user and the other one or more products and the corresponding weighted average propensity to buy for the product currently viewed by the user and the other one or more products.

In an embodiment of the present disclosure, the first set of pre-defined attributes includes intent of the user, the one or more products liked by the user, the one or more products disliked by the user and age of the user. Moreover, the first set of pre-defined attributes includes gender of the user, current location of the user, a type of device utilized by the user, current contextual behavior of the user and past behavior of the user.

In an embodiment of the present disclosure, the second set of pre-defined attributes corresponds to one or more types of events. The one or more types of events include duration of view by the user and the set of users for the product of the one or more products and the other one or more products. In addition, the one or more types of events include search performed by the user and the set of users for searching the product of the one or more products and the other one or more products. Further, the one or more types of events include add to cart event, add to wish list event, a purchase event, checkout initiated event, product view and product reject event.

In another embodiment of the present disclosure, the hybrid recommendation system further includes an assigning module in the processor. The assigning module is configured to assign a value corresponding to each of the one or more types of events for the user and the set of users. The value is assigned to determine a propensity to buy for the product of the one or more products currently viewed by the user and the other one or more products. The value is highest for the purchase event and the value is lowest for the product reject event.

In an embodiment of the present disclosure, the hybrid recommendation system further includes an updation engine in the processor. The updation engine is configured to update the weighted average propensity to buy, the one or more clusters and the first set of pre-defined attributes. In addition, the hybrid recommendation system further updates the first set of parameters, the second set of pre-defined attributes and the recommendation score. The updation is performed at pre-defined continuous intervals of time. The updation is done for refining of recommendation algorithm.

In an embodiment of the present disclosure, the hybrid recommendation system further includes a decision module in the processor. The decision module is configured to take a decision associated with an advertiser of one or more advertisers whose advertisement of the plurality of advertisements will be displayed. Moreover, the advertisement corresponds to the recommended product of the one or more products and the other one or more products. The decision is taken based on a condition specified by the publisher of the one or more publishers.

### BRIEF DESCRIPTION OF THE FIGURES

Having thus described the invention in general terms, reference will now be made to the accompanying drawings, which are not necessarily drawn to scale, and wherein:

FIG. 1A and FIG. 1B illustrates a general overview of a system for hybrid recommendation of one or more advertisements, in accordance with various embodiments of the present disclosure.

FIG. 2 illustrates a block diagram of a hybrid recommendation system, in accordance with various embodiments of the present disclosure.

FIG. 3 illustrates a flowchart for the hybrid recommendation of the one or more advertisements, in accordance with various embodiments of the present disclosure.

FIG. 4 illustrates a block diagram of a communication device, in accordance with various embodiments of the present disclosure.

FIG. 5 illustrates an example snapshot showing classification of one or more users, in accordance with various embodiments of the present disclosure.

FIG. 6 illustrates an example snapshot for showing calculation of weighted average propensity to buy, in accordance with various embodiments of the present disclosure.

FIG. 7 illustrates an example snapshot for calculating a recommendation score, in accordance with various embodiments of the present disclosure.

FIG. 8A, FIG. 8B and FIG. 8C illustrates an example snapshot for taking a decision associated with an advertiser of one or more advertisers, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

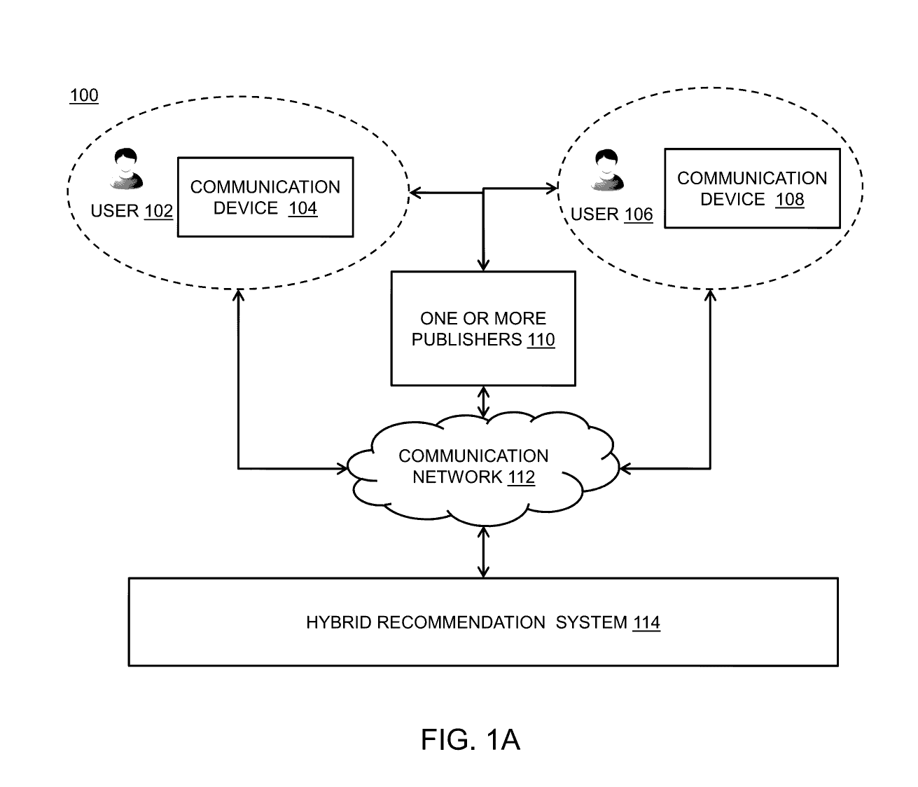

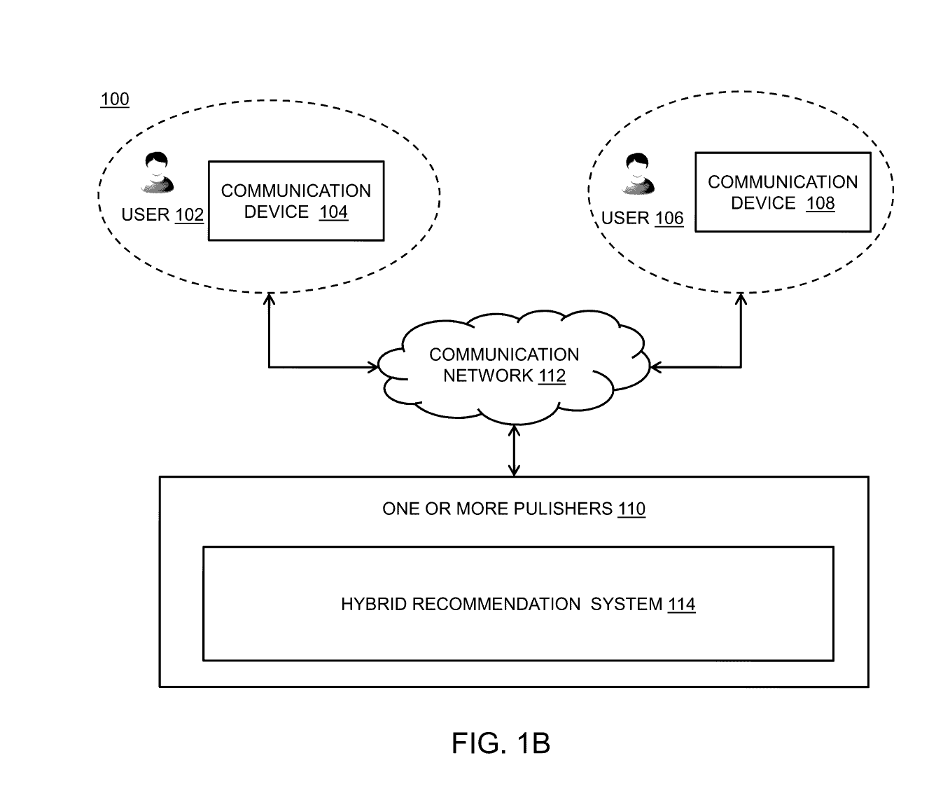

FIG. 1 illustrates a general overview of the system 100 for hybrid recommendation of one or more products viewed by a user of one or more users on a publisher of one or more publishers through one or more advertisements, in accordance with various embodiments of the present disclosure. The system 100 includes a communication device 104 associated with a user 102, a communication device 108 associated with a user 106, one or more publishers 110, a communication network 112 and a hybrid recommendation system 114. The hybrid recommendation system 114 is configured to perform the hybrid recommendation of the one or more products viewed by the user of the one or more users on a publisher of one or more publishers through the one or more advertisements.

Going further, the user 102-106 may be any person or individual accessing the corresponding communication device 104-108. In an embodiment of the present disclosure, the users 102-106 are owners of the corresponding communication device 104 and the communication device 108. Moreover, the communication device 104 and the communication device 108 are portable communication devices. Examples of the communication devices 104-108 include but may not be limited to a smart phone, a desktop computer, a tablet, a laptop, a personal digital assistant or any other electronic portable device presently known in the art. In addition, each of the communication devices 104-108 is connected to an internet broadband system, a local area network, a wide area network, a digital or analog cable television network and the like. The internet broadband system maybe a wired or a wireless system.

Further, the users 102-106 access a browser of one or more browsers on the corresponding communication devices 104-108. Furthermore, the users 102-106 access a website owned by a publisher of the one or more publishers 110 through the browser of the one or more browsers. Examples of the one or more publishers 110 include but may not be limited to facebook, groupon, flipkart, amazon, snapdeal, myntra, jabong and mobile applications. Each of the one or more publishers 110 correspond to one or more website owners for providing or displaying content to the users 102-106. In an embodiment of the present disclosure, the one or more publishers 110 correspond to one or more e-commerce publishers. The one or more e-commerce publishers sell the one or more products. In an embodiment of the present disclosure, the users 102-106 want to buy the one or more products online by accessing the one or more publishers 114. The one or more publishers 110 provide a wide range of the one or more products for the users 102-106 to choose from.

Further, the one or more publishers 110 provide space, areas or a part of their web pages for advertising purposes. These areas or spaces on the web pages are referred to as advertisement slots. The web page can have the various advertisement slots depending on choice of each of the one or more publishers 110. The one or more publishers 110 advertise products, services or businesses to the users 102-104 for generating revenue. It may be noted that the term publisher in context of the present application may be referred to as publisher website which may have advertisement slots for advertising.

In addition, the content accessed by the user 102 and the user 106 may be any content related to interests of the user 104 and the user 106. Moreover, the content accessed by the users 102-106 corresponds to the one or more products associated with the interests of each of the users 102-106. The one or more products include but may not be limited to electronic products (mobiles, tablets, computers, laptops and the like), electrical products, clothing and accessories (jeans, shirts, tops, watches, sunglasses and the like). In addition, the one or more products include household items (kitchen and home appliances, indoor lighting products, pet supplies, home furnishing and the like). Also, the one or more products include footwear products (sneakers, slippers, flip flops, formal shoes and the like) and sports and fitness products (cricket products, football products, exercise products, cycling products and the like).

Moreover, the user 102 and the user 106 may access the content through one or more mobile applications. In an embodiment of the present disclosure, the website or the mobile application accessed by the users 102-106 on the corresponding communication devices 104-108 may show content related to interests of the user 102-104. For example, the user 102 may be interested in footwear products, the electronic products, the sports and fitness products, household products and the like.

Going further, each of the communication devices 104-108 is associated with the hybrid recommendation system 114. In an embodiment of the present disclosure, each of the communication devices 104-108 is associated with the hybrid recommendation system 114 through the communication network 112. In addition, the one or more publishers 110 are associated with the hybrid recommendation system 114. In an embodiment of the present disclosure, the one or more publishers 110 are associated with the hybrid recommendation system 114 through the communication network 112. The communication network 112 enables the hybrid recommendation system 114 to track one or more activities performed by each of the users 102-106 on the corresponding publisher of the one or more publishers 110. Moreover, the communication network 112 provides a medium for transfer of information associated with the users 102-106 to the hybrid recommendation system 114.

Further, the medium for communication may be infrared, microwave, radio frequency (RF) and the like. The communication network 112 includes but may not be limited to a local area network, a metropolitan area network, a wide area network and a virtual private network. Furthermore, the communication network 112 includes a global area network, a home area network or any other communication network presently known in the art. The communication network 112 is a structure of various nodes or communication devices connected to each other through a network topology method. Examples of the network topology include a bus topology, a star topology, a mesh topology and the like.

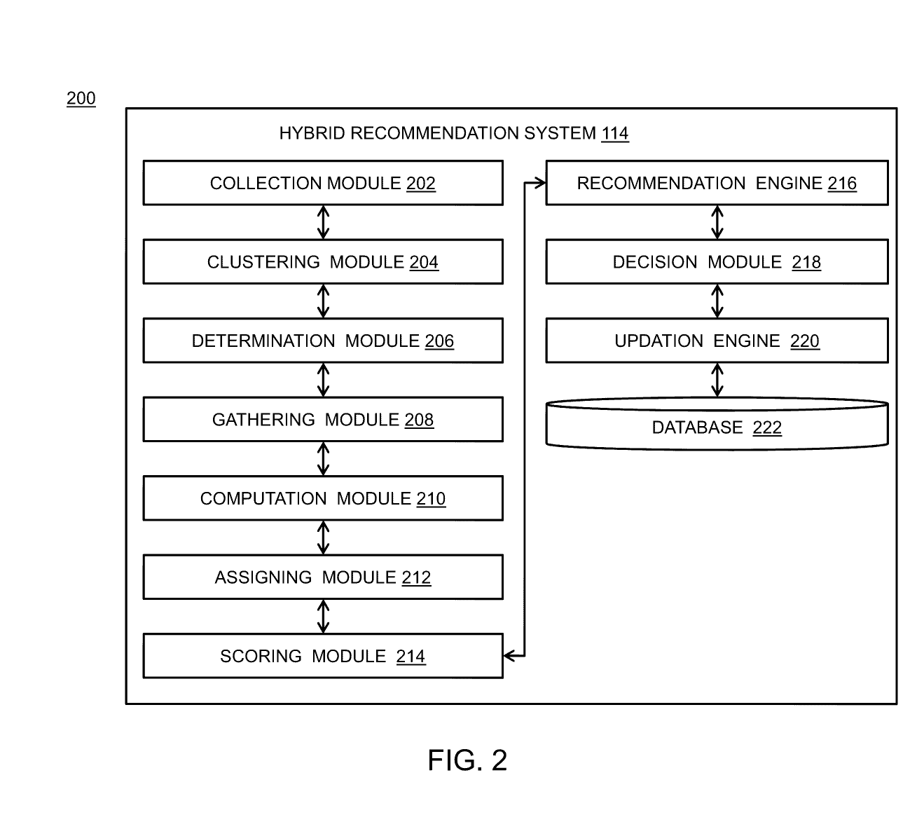

Going further, the hybrid recommendation system 114 is a system for recommendation of the one or more advertisements to the users 102-106 on the corresponding publisher of the one or more publishers 110. Moreover, the hybrid recommendation system 114 records the one or more activities performed by the users 102-106 and recommend the one or more products through the plurality of advertisements based on the one or more activities. The one or more activities include viewing of a product, rejecting of the product, purchase of the product, initiation of checkout of the product and various other similar actions performed by the users 102-106. In an embodiment of the present disclosure, the hybrid recommendation system 114 is configured for recording behavior of the users 102-106 for recommendation of the one or more advertisements associated with the one or more products. Further, the hybrid recommendation system 114 performs an item based recommendation, a user based recommendation, demography based commendation and content based recommendation (as described in detail in the detailed description of FIG. 2). In an embodiment of the present disclosure, the recommended one or more advertisements is displayed in a corresponding one or more advertisement slots on the one or more publishers 110.

In addition, the one or more advertisements are provided by one or more advertisers associated with the one or more publishers 110. The one or more advertisers purchase the advertisement slots from the one or more publishers 110. In an embodiment of the present disclosure, the one or more publishers 110 generate revenue based on one or more compensation techniques. The one or more compensation techniques include but may not be limited to pay per click, pay per view, cost per impression, cost per thousand impressions and the like. In an embodiment of the present disclosure, the one or more publishers 110 and the one or more advertisers have a mutual contract for showing the plurality of advertisements to the users 102-106.

It may be noted that the users 102-106 are associated with the corresponding communication devices 104-108 for accessing the one or more publishers 110 website, however those skilled in the art would appreciate that there are more number of users associated with more number of communication devices for accessing more number of publishers. For example, a user X, a user Y and a user Z are associated with a communication device D1, a communication device D2 and a communication device D3.

In an embodiment of the present disclosure, as illustrated in FIG. 1B, the hybrid recommendation system 114 is a part of the one or more publishers 110. In an embodiment of the present disclosure, the one or more publishers 110 include the hybrid recommendation system 114. In addition, the hybrid recommendation system 114 is located on a backend of each of the one or more publishers 114. In an embodiment of the present disclosure, the one or more publishers 110 are registered on the hybrid recommendation system 114. In another embodiment of the present disclosure, the one or more publishers 110 have an account on the hybrid recommendation system 114. In an embodiment of the present disclosure, the hybrid recommendation system 114 provides a web-based interface for the one or more publishers 110. Moreover, the one or more publishers 110 utilize the web-based interface for setting one or more preferences for targeting the one or more users for recommending the plurality of advertisements.

Going further, the one or more publishers 110 register on the hybrid recommendation system 114 by paying a pre-defined amount of money to avail one or more services of the hybrid recommendation system 114. In an embodiment of the present disclosure, the hybrid recommendation system 114 may accept multiple forms of payment to fund the account. The forms of payment include electronic transfer (e.g., automated clearing house (ACH) transfer or wire transfer) from a designated bank account. Moreover, the forms of payment include credit card (e.g., Visa, MasterCard, Discover, American Express) and online wallet (e.g., PayPal, Amazon Payments and Google Checkout) and/or mobile payment.

In addition, the hybrid recommendation system 114 enables the one or more publishers 110 to download one or more comprehensive reports associated with the one or more activities performed by the users 102-106. In addition, the one or more publishers 110 are enabled to download reports associated with the plurality of advertisements of the one or more products recommended to the users 102-106. The reports help the one or more publishers 110 to gain valuable insight related to the one or more user's interest in the one or more products.

FIG. 2 illustrates a block diagram 200 of the hybrid recommendation system 114, in accordance with various embodiments of the present disclosure. Further, the hybrid recommendation system 114 includes a collection module 202, a clustering module 204, a determination module 206, a gathering module 208, a computation module 210, an assigning module 212, a recommendation engine 214, a scoring module 216, a decision module 218, an updation engine 220 and a database 222. It may be noted that to explain the system elements of FIG. 2, references will be made to the system elements of FIG. 1A and FIG. 1B. In an embodiment of the present disclosure, the above stated modules enable the working of the hybrid recommendation system 114 for recommendation of the one or more advertisements to the users 102-106.

Going further, the user 102 accesses a website of the publisher of the one or more publishers 110 for accessing the content and viewing the one or more products. Moreover, the collection module 202 is configured to collect a first set of pre-defined attributes associated with the user 102 of the one or more users viewing the one or more products on the publisher of the one or more publishers 110. In addition, the first set of pre-defined attributes include but may not be limited to an intent of the user 102, the one or more products liked by the user 102, the one or more products disliked by the user 102 and age of the user 102. Moreover, the first set of pre-defined attributes include gender of the user 102, current location of the user 102, a type of device utilized by the user 102, current contextual behavior of the user 102 and past behavior of the user 102. In an embodiment of the present disclosure, the collection module 202 collects a demographic information of the user 102 for classifying the user 102 into one or more groups based on the first set of pre-defined attributes (as described below in detail in the patent application). In an embodiment of the present disclosure, the collection is done to determine the interests of the user 102 associated with a type of product of one or more types of products. Moreover, the past behavior of the user 102 corresponds to the one or more actions taken by the user 102 against the corresponding one or more products. In an embodiment of the present disclosure, the past behavior illustrates affinity of the user 102 in terms of the one or more products.

Moreover, the first set of pre-defined attributes are collected based on dropping of a cookie on the corresponding communication device 104 associated with the user 102. In an embodiment of the present disclosure, the collection module 202 drops a cookie ID on the communication device 106 when the user 102 accesses the website. The collection module 202 utilizes the cookie ID for extracting information associated with the user 102. In an embodiment of the present disclosure, the user 102 is a frequent visitor on the publisher of the one or more publishers 110. In an embodiment of the present disclosure, the user 102 is visiting the publisher website for the first time.

For example, a user A accesses a publisher P1 (say Flipkart.com) on a browser X1 (say Google Chrome) on a communication device D1 (say a laptop) and a user B accesses a publisher P2 (say Amazon.in) on a browser X2 (say Firefox) on a communication device D2 (say a smart phone). The collection module 204a collects the first set of pre-defined attributes for the user A and the user B. The collection module 204a collects an age of the user A and the user B (say, 22 for the user A and 25 for the user B), a gender of the user A (say, male) and the user B (say, female), location of the user A (say, Delhi) and the user B (say, Mumbai), products liked by the user A (say, shoes) and the user B (say, mobiles).

Further, the clustering module 204 is configured to classify the user 102 of the one or more users in one or more clusters based on the first set of pre-defined attributes. Each cluster of the one or more clusters corresponds to a group of users of the one or more users having a similar liking associated with the product of the one or more products. In an embodiment of the present disclosure, the cluster of the one or more clusters may correspond to a plurality of products. In an embodiment of the present disclosure, the clustering module 204 divides the one or more users based on the type of the product liked by the one or more users and allotting a cluster of the one or more clusters to each of the one or more users. In addition, each cluster of the one or more clusters include users of the one or more users looking for a specific attribute in the product of the one or more products. For example, a user X may be looking for blue colored sneakers of the brand Puma and a user Y may be looking for a smart phone with 1 GB Ram and 8 MP camera. In another example, a user Z may be looking for formal clothes of the brand Van Heusen and black color.

In addition, a number of clusters to be made are performed using a hierarchical classification. In an embodiment of the present disclosure, the number of clusters to be created is determined by using a dendogram technique. Moreover, the one or more clusters are created by utilizing a K means cluster technique for identifying the cluster of the one or more clusters corresponding to the product of the one or more products currently viewed by the user 102. In an embodiment of the present disclosure, a new user (say user 106) of the one or more users with a new browsing history is classified into the one or more clusters immediately. In an embodiment of the present disclosure, profiling of each cluster of the one or more clusters is done based on means and standard deviations of variables present in each of the cluster of the one or more clusters. The profiling of the one or more clusters corresponds to assigning a type of the product viewed by the user 102.

In an embodiment of the present disclosure, the one or more clusters are already present in the hybrid recommendation system 114 for classifying the user 102 into the one or more clusters. Further, the one or more clusters are created based on a first set of parameters. The first set of parameters include but may not be limited to demography of the user 102 and one or more details associated with the product of the one or more products currently viewed by the user 102. Also, the first set of parameters includes one or more attributes associated with the product of the one or more products currently viewed by the user 102. The one or more attributes differ for each type of the product viewed by the one or more users. Further, the one or more attributes of the product are determined based on an identification of the cluster of the one or more clusters (as described below in the patent application). In an embodiment of the present disclosure, the user 102 may belong to a plurality of clusters based on the first set of parameters. For example, a user K views mobile products and accessories and also views one or more clothing products.

Moreover, the classification and the clustering of the user 102 are performed for the identification of the cluster of the one or more clusters to which the user 102 belongs. In addition, the identification of the cluster of the one or more clusters is based on calculation of an average cluster centroid. Further, the calculation is done for determining the cluster of the one or more clusters to which the user 102 is closest. In an embodiment of the present disclosure, the average cluster centroid is calculated for a known user (the user 102) searching and viewing the one or more products. Moreover, the one or more clusters are created for identification of one or more parameters for the clustering. The one or more parameters aid the hybrid recommendation system 114 for finding out an attribute of the one or more attributes associated with the product having a higher degree of importance for the user 102.

Going further, the one or more parameters are identified or determined using a logistic regression technique or a discriminant analysis technique. In an embodiment of the present disclosure, the one or more parameters are identified for determining the attribute which impacts a buying decision for the user 102. In addition, the hybrid recommendation system 114 utilizes a stepwise discriminant analysis and a structure matrix for finding the one or more parameters impacting the buying decision for the user 102. Moreover, the clustering is done at pre-defined intervals of time. In an embodiment of the present disclosure, the set of parameters and the one or more parameters are analyzed at the pre-defined intervals of time.

In an embodiment of the present disclosure, the average cluster centroid for the user 102 is calculated by utilization of values of cluster centroid for a particular cluster corresponding to the plurality of products. The plurality of products belongs to the particular cluster viewed by the user 102. The values of the cluster centroid are averaged. The cluster centroid corresponds to a middle of the cluster. The calculated average cluster centroid value is used for determination of the product currently viewed by the user 102. The determination is based on a degree of closeness of the average cluster centroid value with the cluster centroid values for the particular cluster. Moreover, the determination of the product is done by utilizing a product ID and a product name provided in the cluster.

Continuing the above stated example, the clustering module 204 classifies the user A into a cluster C1 made up of Puma sneaker P, Nike sneaker N and Adidas sneaker AD and classifies the user B into a cluster C2 made up of a mobile phone M1 (say Samsung Galaxy Core 2 duos), a mobile phone M2 (say Samsung Galaxy Grand Prime) and a mobile phone M3 (say Samsung Galaxy S5). The cluster centroid for the cluster Cl for the puma sneaker P is 6.17544, the Nike sneaker N is 10.82456 and the Adidas sneaker AD is 11.82456. Moreover, the cluster centroid for the cluster C2 for the mobile phone M1 is 6.17544, for the mobile phone M2 is 10.82546 and for the mobile phone M3 is 0.82546. The average cluster centroid for the cluster Cl for the user A is 9.61 and for the cluster C2 for the user B is 6.27. The cluster module 204 determines that the user A is closest to the cluster for the Nike sneaker N and determines that the user B is closest to the cluster for the mobile phone M1 (Samsung Galaxy Core 2 duos). The clustering module 204b determines that the user A is viewing the Nike sneaker N based on product ID and name given in the cluster C1 for the Nike sneaker N and determines that the user B is viewing the mobile phone M1 (Samsung Galaxy Core 2 duos) based on product ID and name given in the cluster C2 for the mobile phone M1 (Samsung Galaxy Core 2 duos).

Going further, the determination module 206 determines one or more characteristics associated with the product of the one or more products currently viewed by the user 102 of the one or more users. The one or more characteristics correspond to the one or more attributes associated with the product of the one or more products. In addition, the one or more characteristics are different for each type of the product of the one or more products. The determination of the one or more characteristics is based on the identification of the cluster of the one or more clusters by the calculation of the average cluster centroid. The one or more characteristics associated with the product currently viewed by the user 102 are determined by the identification of the product through the product ID. In addition, the one or more characteristics are determined by the product name provided in the cluster corresponding to the product determined by the average cluster centroid value (as exemplary stated above in the patent application).

In an embodiment of the present disclosure, the determination module 206 determines a limited number of characteristics of the corresponding product. For example, a user J viewing a smartphone (say Apple iPhone 5S) on a website. The determination module 206 determines model name and model ID of the smart phone and determines some characteristics (say, brand, color and price) of the one or more characteristics associated with the smartphone. In an embodiment of the present disclosure, in such a case, the determination module 206 utilizes a scrapped data and look alike modeling for determining the one or more characteristics and information related to the product searched by the user 102. In an embodiment of the present disclosure, this approach is utilized by the publisher of the one or more publishers 110 not associated with e-commerce background. For example, the user J accesses a website (say groupon.com) for accessing coupons for smartphones. The user J views a coupon for an Apple iPhone 5S device. The determination module 206 determines that the user J is looking for smartphones of the brand Apple and the phone Apple iPhone 5S.

In addition, the gathering module 208 gathers data associated with other one or more products similar to the product currently viewed by the user 102. The data is gathered based on the determination of the one or more characteristics and the identification of the cluster of the one or more clusters. Moreover, the other one or more products have similar characteristics to the one or more characteristics associated with the product of the one or more products currently viewed by the user 102. In an embodiment of the present disclosure, the other one or more products correspond to a similar product category associated with the product currently viewed by the user 102. Moreover, the other one or more products are determined using the one or more characteristics determined for the product viewed by the user 102 and finding similar products (the other one or more products). The similar products possess the one or more characteristics.

In an embodiment of the present disclosure, accuracy of the gathered data is based on a level of the one or more characteristics determined for the product of the one or more products currently viewed by the user 102. The level of the one or more characteristics corresponds to a number of significant characteristics which will help in finding out the other one or more products similar to the product currently viewed by the user 102. Further, the other one or more products belong to the identified cluster of the one or more clusters corresponding to the product of the one or more products currently viewed by the user 102.

In an embodiment of the present disclosure, the other one or more products are identified in a separate cluster having the similar characteristics of the one or more characteristics. Moreover, the other one or more products are identified by using a cosine similarity technique. In an embodiment of the present disclosure, the hybrid recommendation system 114 utilizes the cosine similarity technique for calculating a value of similarity between the product of the one or more products currently viewed by the user 102 with each of the other one or more products identified.

Extending the above stated example, the user B is currently viewing at the mobile phone M1 (Samsung Galaxy Core 2 duos) as determined by the clustering module 206. The determination module 206 determines the one or more characteristics associated with the mobile phone M1 (say, model id is SM-G355HZWDINU, mobile id is 2, brand is Samsung, color is white, operating system is Android and the like). The gathering module 208 utilizes the one or more characteristics of the mobile phone M1 to find other mobile phones (say, A106, A501CG-Black, A501CG—Blue, A501CG—White, A501CG—Red, X2—green, X2—Black, X2—White, X2—Yellow, XT1022, AQ4501—Black, AQ4501—White, X5—Black, X5—White and A104—Grey).

In an embodiment of the present disclosure, the other one or more products are identified based on a propensity to buy. The propensity to buy is pre-calculated based on interactions of other one or more users with the other one or more products. In addition, the other one or more products having the highest propensity to buy are selected (as described below in the patent application).

Going further, the computational module 210 computes a weighted average propensity to buy for the user 102 of the one or more users. The weighted average propensity to buy corresponds to a probability of the user 102 to buy the product of the one or more products currently viewed by the user 102. In addition, the weighted average propensity to buy is computed for the product of the one or more products currently viewed by the user 102 of the one or more users. Also, the weighted average propensity to buy is computed for the other one or more products similar to the product currently viewed by the user 102. Moreover, the weighted average propensity to buy is computed based on a second set of pre-defined attributes and a pre-defined criterion. Further, the pre-defined criterion is based on analyzing a past behavior of a set of users of the one or more users who have bought the product of the one or more products and the other one or more products. Furthermore, the pre-defined criterion is based on one or more actions taken corresponding to the product of the one or more products and the other one or more products.

Furthermore, the second set of pre-defined attributes corresponds to one or more types of events taken place during interaction of the set of users with the product of the one or more products and the other one or more products. The one or more types of events include but may not be limited to duration of view by the user 102 and the set of users for the product of the one or more products and the other one or more products. In addition, the one or more types of events include search performed by the user 102 and the set of users for searching the product of the one or more products and the other one or more products. Moreover, the one or more types of events include add to cart event, add to wish list event, a purchase event, checkout initiated event, product view and product reject event.

Further, the weighted average propensity to buy is calculated by usage of a number of users corresponding to each of the one or more types of events for each of the other one or more products and the product viewed by the user 102. In addition, the number of users is multiplied by a propensity to buy value assigned for each of the one or more types of events (as described later in the patent application) for calculating the weighted average propensity to buy. In an embodiment of the present disclosure, the weighted average propensity to buy is calculated for a fixed interval of time.

In an embodiment of the present disclosure, the weighted average propensity to buy is pre-calculated for the other one or more products. In an embodiment of the present disclosure, the weighted average propensity to buy may change for the product of the one or more products currently viewed by the user 102. In an embodiment of the present disclosure, the weighted average propensity to buy for the other one or more products is fetched. In another embodiment of the present disclosure, the other one or more products with the highest weighted average propensity to buy are fetched.

Continuing the above stated example, the computational module 210 calculates the weighted average propensity to buy for the mobile phone M1 (Samsung Galaxy Core 2 Duos) and the other mobile phone (say, A106, A501CG—Black, A501CG—Blue, A501CG—White, A501CG—Red, X2—green, X2—Black, X2—White, X2—Yellow, XT1022, AQ4501—Black, AQ4501—White, X5—Black, X5—White, A104—Grey and A104—Grey). The weighted average propensity to buy for the mobile phone M1 (Samsung Galaxy Core 2 Duos) is calculated by adding number of users for each of the one or more types of events (say, 10 for purchased event, 11 for checkout initiated event, 12 for add to cart event, 4 for add to wish list event, 28 for product view event, 2 for product search event and 39 for product reject event). The number of users is 106. Further, the weighted average propensity to buy is calculated by dividing an output of addition of product of the number of users for each of the one or more types of events with the propensity to buy value assigned for each of the one or more types of events (say 501) with the total number of users for the mobile phone M1 (106). The weighted average propensity to buy is 4.726. Similarly, the computational module 210 calculates the weighted average propensity to buy for the other mobile phone (say, A106, A501CG—Black, A501CG—Blue, A501CG—White, A501CG—Red, X2—green, X2—Black, X2—White, X2—Yellow, XT1022, AQ4501—Black, AQ4501—White, X5—Black, X5—White and A104—Grey).

Going further, the assigning module 212 assigns a value corresponding to each of the one or more types of events for the user and the set of users. The value is assigned to determine the propensity to buy for the product of the one or more products currently viewed by the user 102 and the other one or more products. Moreover, the assigned value is highest for the purchase event and the value is lowest for the product reject event. In an embodiment of the present disclosure, the value is utilized for the calculation of the weighted average propensity to buy for the product of the one or more products currently viewed by the user 102 and the other one or more products. In an embodiment of the present disclosure, the assigning module 212 assigns a value of 10 for the purchase event, a value of 9 for the checkout initiated event and a value of 8 for the add to cart event. In addition, the assigning module 212 assigns a value of 7 for the add to wish list event, a value of 6 for the product view event, a value of 5 for the product search event and a value of 0 for the product reject event.

Moreover, the scoring module 214 calculates a recommendation score for the product of the one or more products currently viewed by the user 102 of the one or more users and the other one or more products. In addition, the recommendation score is calculated based on multiplication of the similarity of the product currently viewed by the user 102 and the other one or more products and the corresponding weighted average propensity to buy.

Extending the above stated example, the propensity to buy for the mobile phone M1 is 0.5. The similarity of the mobile phone M1 with the mobile phone M1 is 1. The scoring module 214 calculates the recommendation score for the mobile phone M1 (1*0.5=0.5). Similarly, the scoring module 214 calculates the recommendation score for the A106 (0.999*0.75=0.749), A5010G—Black (0.999*1=0.999), A5010G—Blue (0.999*1=0.999), A5010G—White (0.999*0.5=0.500), A5010G—Red (0.999*0=0.000), X2—green (1.000*1=1.000), X2—Black (1.000*1=1.000), X2—White (1.000*1=1.000), X2—Yellow (1.000*0=0.000), XT1022 (0.999*1=0.999), AQ4501—Black (1.000*1=1.000), AQ4501—White (1.000*1=1.000), X5—Black (0.999*1=0.999), X5—White (0.999*1=0.999) and A104—Grey (0.999*1=0.999).

In an embodiment of the present disclosure, the hybrid recommendation system 114 sorts the product and the other one or more products based on the recommendation score in a descending order. The sorting is done based on the weighted average propensity to buy and the calculated recommendation score. In an embodiment of the present disclosure, the hybrid recommendation system 114 selects a pre-defined number of products from the sorted list of the product and the other one or more products. In an example, the hybrid recommendation system 114 selects a top 10 products from the sorted list for recommendation to the user 102.

Going further, the recommendation engine 216 recommends the one or more advertisements associated with the product of the one or more products currently viewed by the user 102 and the other one or more products. The other one or more possess the highest weighted average propensity to buy. In an embodiment of the present disclosure, the recommendation engine 204h recommends the one or more advertisements based on the highest recommendation score. The one or more advertisements may be a banner advertisement, a textual advertisement, html advertisement and the like. In an embodiment of the present disclosure, the one or more advertisements is displayed in the corresponding one or more advertisement slots in the one or more publishers 110. Moreover, the one or more advertisements is provided by the one or more advertisers in real time.

In an example, the recommendation engine 216 recommends the top 10 products through the plurality of advertisements from the sorted list of the products and the other one or more products. Further, the recommendation of the one or more advertisements associated with the product and the other one or more products with the highest weighted average propensity to buy is based on seller rating. Furthermore, the recommendation of the one or more advertisements is based on a price of the product of the one or more products and the other one or more products recommended to the user 102. In addition, the recommendation of the one or more advertisements is based on a click through rate and a seller bid for a particular ad format and publisher combination.

In an embodiment of the present disclosure, each of the product and the other one or more products are recommended through a corresponding single advertisement. In an embodiment of the present disclosure, the product currently viewed by the user 102 on an e-commerce publisher of the one or more publishers 110 is not recommended to the user 102. The product is not recommended when no third party product listing ad is allowed by the e-commerce publisher. In an embodiment of the present disclosure, the recommendation of the product currently viewed by the user 102 is allowed if the e-commerce publisher allows the third party product listing ad. Also, the recommendation of the product currently viewed by the user 102 is allowed if the recommendation score recommends the product from other advertiser of the one or more advertisers.

In an embodiment of the present disclosure, the recommendation engine 216 does not recommend products which are already bought by the user 102. In an embodiment of the present disclosure, the recommendation engine 216 recommends recently viewed products to the user 102. In an embodiment of the present disclosure, the hybrid recommendation system 114 performs the recommendation of the recently viewed products by two methods. In an embodiment of the present disclosure, first method of the two methods finds the similarity between the product of the one or more products currently viewed by the user 102 with the recently viewed products. Accordingly, the first method calculates a new propensity to buy for each of the recently viewed products based on data associated with the other one or more users. In another embodiment of the present disclosure, second method of the two methods recommends the recently viewed products irrespective of the similarity with the product currently viewed by the user 102.

Extending the above stated example, the recommendation engine 216 recommends the other mobile phones (X2—green, X2—Black, X2—White, AQ4501—Black and AQ4501—White) having the highest weighted average propensity to buy (1.000) for the user B.

Further, the decision module 218 decides an advertiser of the one or more advertisers whose advertisement of the one or more advertisements corresponding to the recommended product will be displayed. The advertisement corresponds to an advertisement of the one or more products and the other one or more products. Furthermore, the decision is taken based on a condition specified by the publisher of the one or more publishers 110. The condition specified by the publisher of the one or more publishers 110 corresponds to a choice of the publisher for allowing one or more third party product listing advertisements. In an embodiment of the present disclosure, the decision module 218 takes the decision based on when the publisher of the one or more publishers 110 does not allow the one or more third party product listing advertisements. In another embodiment of the present disclosure, the decision module 218 takes the decision based on when the publisher of the one or more publishers 110 allows the one or more third party product listing advertisements.

Going further, in an embodiment, the decision module 218 checks availability of the recommended product of the one or more products and the other one or more products with the publisher. Also, the decision module 218 recommends the available products to the user 102 through the corresponding advertisements of the plurality of advertisements. In an embodiment, the decision module 218 checks and recommends when the publisher of the one or more publishers 110 does not allow the one or more third party product listing advertisements on the website. In an embodiment of the present disclosure, the decision module 218 performs the decision based on the availability of the product and the other one or more products with a single seller of the publisher of the one or more publishers 110.

In an embodiment of the present disclosure, in this case, the decision module 218 takes the decision based on the ad format of a plurality of ad formats having a highest value of product of click through rate (CTR) and click rate (CR). In an embodiment of the present disclosure, the decision module 218 analyzes the click through rate (CTR) and the click rate (CR) for each of the plurality of ad formats. Further, the recommended product is recommended in the ad format having the highest value of the product of click through rate (CTR) and click rate (CR). In an embodiment of the present disclosure, the decision module 218 displays the recommended product in the ad format pre-selected by the publisher of the one or more publishers 110.

Also, the decision module 218 performs the decision based on the availability of the recommended product and the other one or more products with a plurality of sellers of the publisher of the one or more publishers 110. Further, in this case, the decision module 218 takes the decision based on deciding a seller of the plurality of sellers whose product will be displayed. Moreover, the decision is taken based on a seller rating of each of the plurality of sellers, a delivery time for each of the plurality of sellers and a price of the product for each of the plurality of sellers. Further, the decision is taken based on a margin to the advertiser of the one or more advertisers for each of the plurality of sellers, an advertisement budget for each of the plurality of sellers and a bidding price for each of the plurality of sellers. In addition, the decision module 218 calculates a final score for each of the plurality of sellers. Further, the decision module 218 displays the advertisement of the recommended product corresponding to the seller of the plurality of sellers with the highest final score.

Furthermore, the decision module 218 takes the decision based on whether the recommended product is available with a single advertiser of the one or more advertisers. Also, the decision module 218 takes the decision based on whether the recommended product is available with a plurality of advertisers. In an embodiment, the decision module 218 takes the decision when the publisher of the one or more publishers 110 allows the one or more third party product listing advertisements on the website. The decision module 218 recommends the product available with the single advertiser after deciding of the ad format with the highest value of the product of the click through rate (CTR) and the click rate (CR).

In another embodiment of the present disclosure, the decision module 218 takes the decision for the recommended product available with the plurality of advertisers based on a plurality of attributes. The plurality of attributes include but may not be limited to a sale price of the recommended product for each of the plurality of advertisers and a sale price inverse of the recommended product for each of the plurality of advertisers. In addition, the plurality of attributes includes one or more creative type associated with each of the plurality of advertisers, product of the click through rate (CTR). Further, the plurality of attributes includes the click rate (CR) for each of the one or more creative type for each of the plurality of advertisers. Furthermore, the plurality of attributes includes an advertiser bid value for each of the plurality of advertisers and a percentage of margin received by the publisher of the one or more publishers 110.

Further, a final recommendation score is calculated based on the plurality of attributes. Moreover, the final recommendation score is calculated based on multiplication of the sale price inverse, the product of the click through rate (CTR) and the click rate (CR), the advertiser bid value and the percentage of margin received by the publisher. In addition, the decision module 218 recommends the product for the advertiser of the one or more advertiser with the highest final recommendation score.

Also, the hybrid recommendation system 114 utilizes demography of a new user, details of a communication device utilized for accessing the publisher and one or more attributes of the product currently viewed by the new user. In addition, the hybrid recommendation system 114 classifies the new user into the one or more clusters when the new user of the one or more user accesses the publisher of the one or more publishers 110. In an embodiment of the present disclosure, the one or more clusters are created based on the demography if the one or more parameters cannot be identified for the clustering.

Moreover, in a case, when a new product of the one or more products is introduced by the publisher of the one or more publishers 110 for which no user behavior has been captured by the hybrid recommendation system 114. Accordingly, the new product is classified into the one or more clusters based on the one or more attributes of the new product found using the discriminant analysis method. Moreover, the propensity to buy for the new product is calculated based on the one or more attributes in the identified cluster. In addition, a multinomial linear regression method is utilized for calculating the propensity to buy for the new product. In an embodiment of the present disclosure, the new product is re-classified based on capturing of the user behavior for the new product and the one or more attributes of the new product.

Going further, the updation engine 220 updates the weighted average propensity to buy, the one or more clusters, the first set of pre-defined attributes and the first set of parameters. Also, the updation engine 220 updates the second set of pre-defined attributes and the recommendation score. The updation is performed at pre-defined continuous intervals of time. The updation is done for refining of recommendation algorithm. In addition, the database 222 stores the weighted average propensity to buy, the one or more clusters, the first set of pre-defined attributes, the first set of parameters, the second set of pre-defined attributes and the recommendation score.

It may be noted that in FIG. 2, various modules of the hybrid recommendation system 114 are shown that illustrates the working of the hybrid recommendation system 114; however those skilled in the art would appreciate that the hybrid recommendation system 114 may have more number of modules that could illustrate overall functioning of the hybrid recommendation system 114.

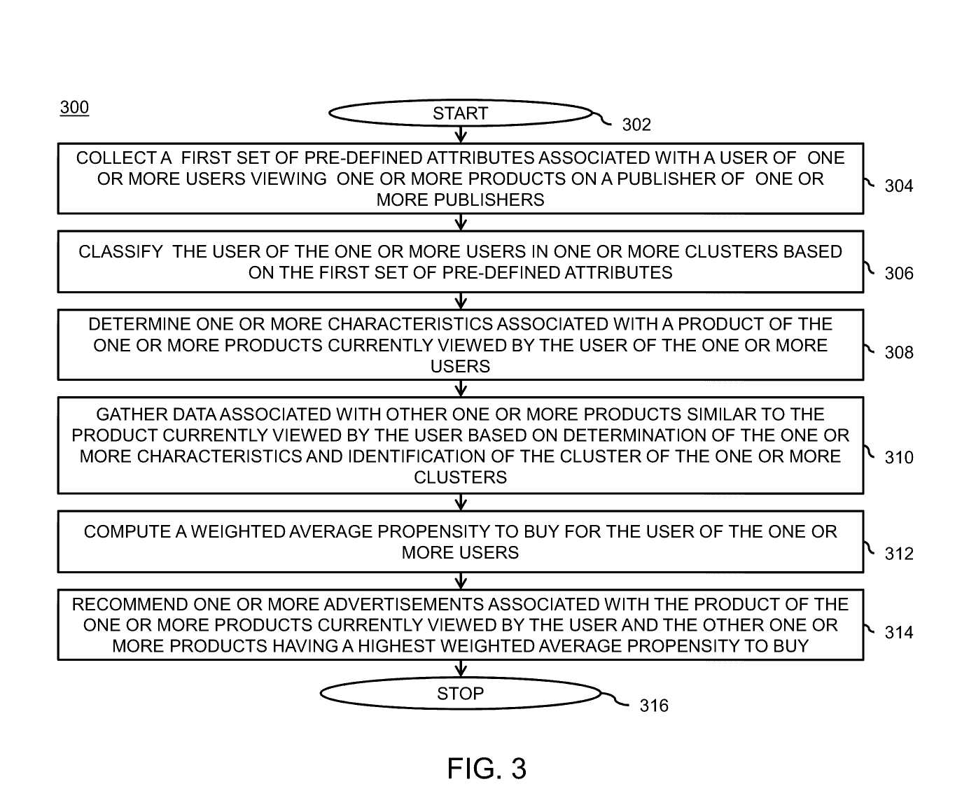

FIG. 3 illustrates a flow chart 300 for the hybrid recommendation of the one or moe products viewed by the one or more users through the one or more advertisments, in accordance with various embodiments of the present disclosure. It may be noted that to explain the process steps of flowchart 300, references will be made to the system elements of the FIG. 1, and the FIG. 2. It may also be noted that the flowchart 300 may have lesser or more number of steps.

The flowchart 300 initiates at step 302. Following step 302, at step 304, the collection module 202 collects the first set of pre-defined attributes associated with the user 102 of the one or more users viewing the one or more products on the publisher of the one or more publishers 110. At step 306, the clustering module 204 classifies the user 102 of the one or more users in the one or more clusters based on the first set of pre-defined attributes. At step 308, the determination module 206 determines the one or more characteristics associated with the product of the one or more products currently viewed by the user 102 of the one or more users. At step 310, the gathering module 208 gathers the data associated with the other one or more products similar to the product currently viewed by the user 102. The data is gathered based on the determination of the one or more characteristics and the identification of the cluster of the one or more clusters. At step 312, the computational module 210 computes the weighted average propensity to buy for the user 102 of the one or more users. At step 314, the recommendation engine 216 recommends the one or more advertisements associated with the product of the one or more products currently viewed by the user 102 and the other one or more products. The other one or more products have a highest weighted average propensity to buy. The flow chart 300 terminates at step 316.

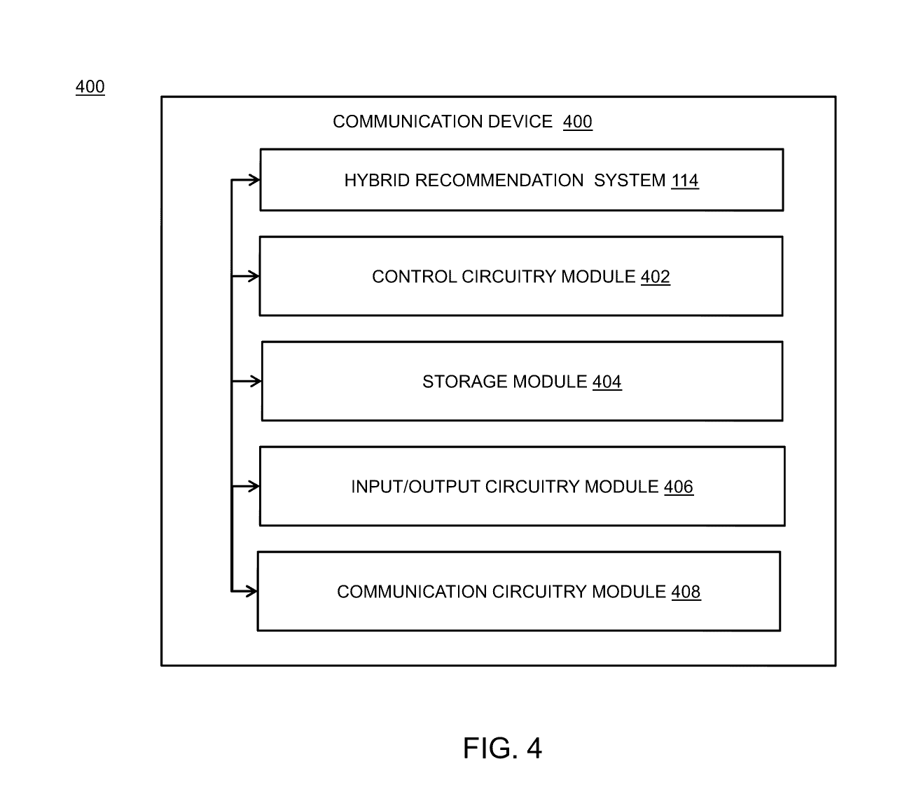

FIG. 4 illustrates a block diagram 400 of a communication device, in accordance with various embodiments of the present disclosure. The communication device enables the hosting of the hybrid recommendation system 114. The communication device includes a control circuitry module 402, a storage module 404, an input/output circuitry module 406, and a communication circuitry module 408. The communication device includes any suitable type of portable electronic device. The communication device includes but may not be limited to a personal e-mail device (e.g., a Blackberry™ made available by Research in Motion of Waterloo, Ontario), a personal data assistant (“PDA”), a cellular telephone. In addition, the communication device includes a smart phone, the laptop, computer and the tablet. In another embodiment of the present disclosure, the communication device can be a desktop computer.

From the perspective of this disclosure, the control circuitry module 402 includes any processing circuitry or processor operative to control the operations and performance of the communication device. For example, the control circuitry module 402 may be used to run operating system applications, firmware applications, media playback applications, media editing applications, or any other application.

In an embodiment of the present disclosure, the control circuitry module 402 drives a display and process inputs received from the user interface. From the perspective of this disclosure, the storage module 404 includes one or more storage mediums. The one or more storage medium includes a hard-drive, solid state drive, flash memory, permanent memory such as ROM, any other suitable type of storage component, or any combination thereof. The storage module 404 may store, for example, media data (e.g., music and video files), application data (e.g., for implementing functions on the communication device).

From the perspective of this disclosure, the I/O circuitry module 406 may be operative to convert (and encode/decode, if necessary) analog signals and other signals into digital data. In an embodiment of the present disclosure, the I/O circuitry module 406 may convert the digital data into any other type of signal and vice-versa. For example, the I/O circuitry module 406 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 402, the storage module 404, or any other component of the communication device.

It may be noted that the I/O circuitry module 406 is illustrated in FIG. 4 as a single component of the communication device; however those skilled in the art would appreciate that several instances of the I/O circuitry module 406 may be included in the communication device.

The communication device may include any suitable interface or component for allowing the user to provide inputs to the I/O circuitry module 406. The communication device may include any suitable input mechanism. Examples of the input mechanism include but may not be limited to a button, keypad, dial, a click wheel, and a touch screen. In an embodiment, the communication device may include a capacitive sensing mechanism, or a multi-touch capacitive sensing mechanism.

In an embodiment of the present disclosure, the communication device may include specialized output circuitry associated with output devices such as, for example, one or more audio outputs. The audio output may include one or more speakers built into the communication device, or an audio component that may be remotely coupled to the communication device.

The one or more speakers can be mono speakers, stereo speakers, or a combination of both. The audio component can be a headset, headphones or ear buds that may be coupled to the communication device with a wire or wirelessly.

In an embodiment, the I/O circuitry module 406 may include display circuitry for providing a display visible to a user. For example, the display circuitry may include a screen (e.g., an LCD screen) that is incorporated in the communication device.

The display circuitry may include a movable display or a projecting system for providing a display of content on a surface remote from the communication device (e.g., a video projector). In an embodiment of the present disclosure, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 402. Alternatively, the display circuitry may be operative to provide instructions to a remote display.

In addition, the communication device includes the communication circuitry module 408. The communication circuitry module 408 may include any suitable communication circuitry operative to connect to a communication network. In addition, the communication circuitry module 408 may include any suitable communication circuitry to transmit communications (e.g., voice or data) from the communication device to other devices. The other devices exist within the communications network. The communications circuitry 408 may be operative to interface with the communication network through any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communications circuitry module 408 may be operative to create a communications network using any suitable communications protocol. For example, the communication circuitry module 408 may create a short-range communication network using a short-range communications protocol to connect to other devices. For example, the communication circuitry module 408 may be operative to create a local communication network using the Bluetooth, RTM protocol to couple the communication device with a Bluetooth® headset.

It may be noted that the computing device is shown to have only one communication operation; however, those skilled in the art would appreciate that the communication device may include one more instances of the communication circuitry module 408 for simultaneously performing several communication operations using different communication networks. For example, the communication device may include a first instance of the communication circuitry module 408 for communicating over a cellular network, and a second instance of the communication circuitry module 408 for communicating over Wi-Fi or using Bluetooth®.

In an embodiment of the present disclosure, the same instance of the communications circuitry module 408 may be operative to provide for communications over several communication networks. In another embodiment of the present disclosure, the communication device may be coupled to a host device for data transfers and sync of the communication device. In addition, the communication device may be coupled to software or firmware updates to provide performance information to a remote source (e.g., to providing riding characteristics to a remote server) or performing any other suitable operation that may require the communication device to be coupled to the host device. Several computing devices may be coupled to a single host device using the host device as a server. Alternatively or additionally, the communication device may be coupled to the several host devices (e.g., for each of the plurality of the host devices to serve as a backup for data stored in the communication device).

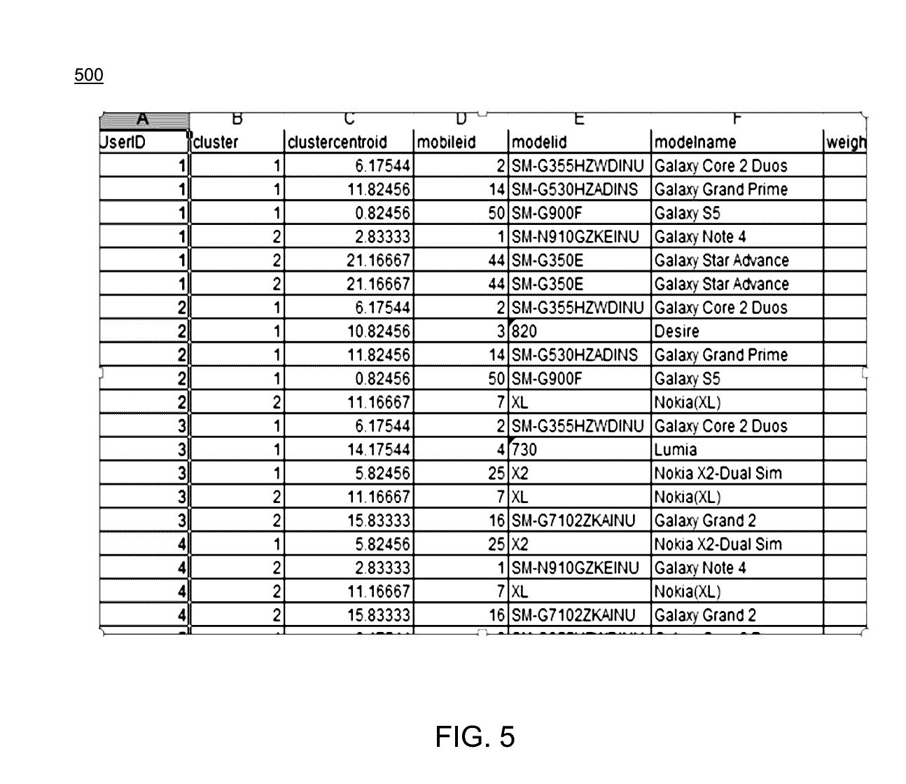

FIG. 5 illustrates an example snapshot 500 showing classification of the one or more users into one or more clusters, in accordance with various embodiments of the present disclosure. Moreover, the snapshot shows the classification of the one or more users (a user 1, a user 2, a user 3 and a user 4) into the one or more clusters (a cluster 1 and a cluster 2) based on a model id and a model name. The one or more users view one or more mobile phones. Further, the user 1 belongs to the cluster 1 and the c1uster 2. Similarly, the user 2, the user 3 and the user 4 belongs to the cluster 1 and the cluster 2. In addition, the user 1 is associated with viewing of three mobile devices (Samsung Galaxy Core 2 Duos, Samsung Galaxy Grand Prime and Samsung Galaxy S5).

Moreover, the average cluster centroid for each of the mobile device for the corresponding cluster is provided. In addition, the average cluster centroid for the user 1 associate with the cluster 1 is determined by taking the average of the cluster centroid for the cluster 1 corresponding to the user 1. In an example, as shown in FIG. 5, the average cluster centroid for the user 1 associated with the cluster 1 is 6.27. The average cluster centroid value determines that the user 1 is viewing the Samsung Galaxy Core 2 Duos mobile device with the model id SM-G355HZWDINU.

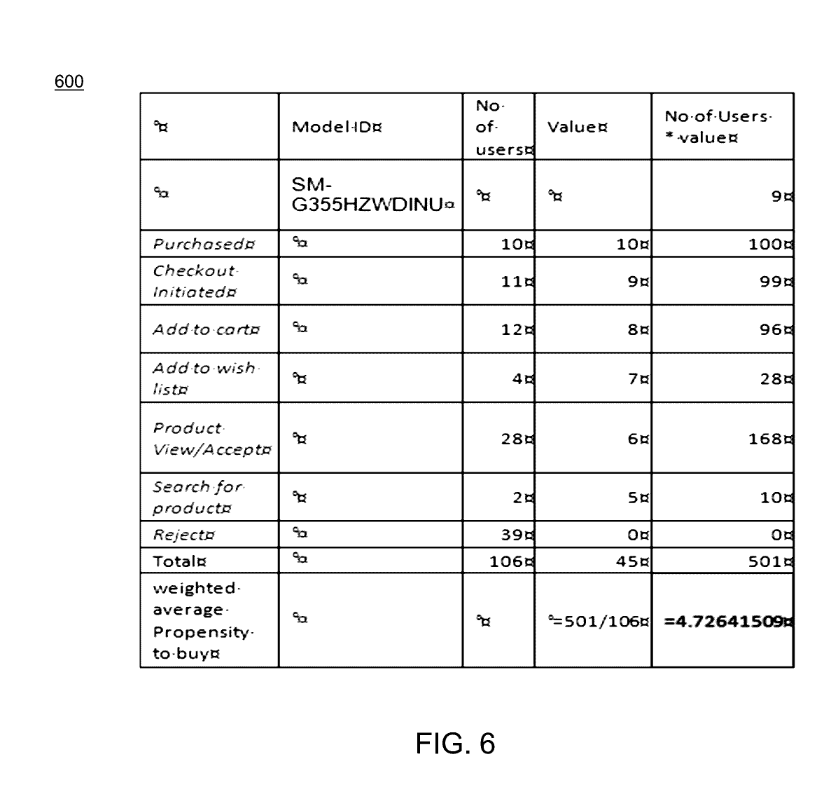

FIG. 6 illustrates an example snapshot 600 for showing the calculation of the weighted average propensity to buy, in accordance with various embodiments of the present disclosure. As shown in the FIG. 6, the weighted average propensity to buy is calculated for the product with the model id SM-G355HZWDINU based on the one or more types of events for the set of users who have interacted with the Samsung Galaxy Core 2 Duos mobile device. The number of users is provided for each of the one or more types of events. Moreover, the propensity to buy value is provided for each of the one or more types of events. In addition, the product of the number of users and the propensity to buy is provided for each of the one or more types of events. Further, the weighted average propensity to buy is calculated by dividing the product of the number of users and the propensity to buy (501) with the number of users (106). The weighted average propensity to buy is 4.72641509 for the Samsung Galaxy Core 2 Duos mobile device.

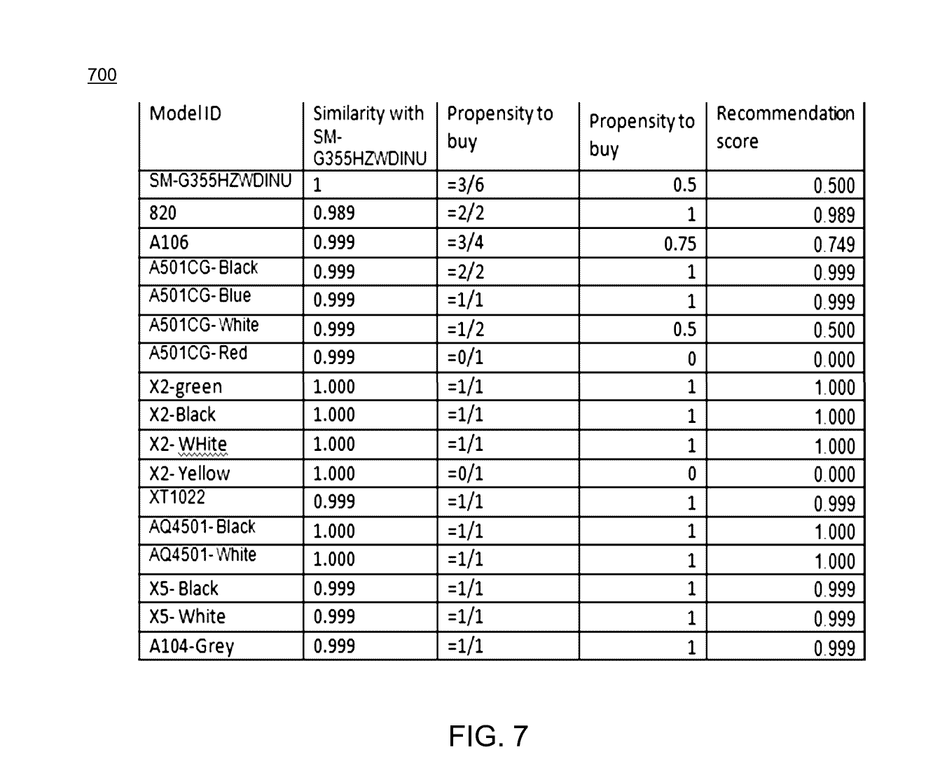

FIG. 7 illustrates an example snapshot 700 for calculating the recommendation score, in accordance with various embodiments of the present disclosure. Moreover, the recommendation score is calculated for each of the other one or more products and the products of the one or more products currently viewed by the user 102 (Samsung Galaxy Core 2 Duos). In addition, the recommendation score is calculated by multiplying the similarity of the product of the one or more products currently viewed by the user 102 (Samsung Galaxy Core 2 Duos) with the other one or more products (820, A106, A501CG—Black, A501CG—Blue, A501CG—White, A501CG—Red, X2—green, X2—Black, X2—White, X2—Yellow, XT1022, AQ4501—Black, AQ4501—White, X5—Black, X5—White and A104—Grey) with the propensity to buy for each of the corresponding other or more products and the product of the one or more products currently viewed by the user 102. The recommendation score for each of the other one or more products and the product currently viewed is provided.

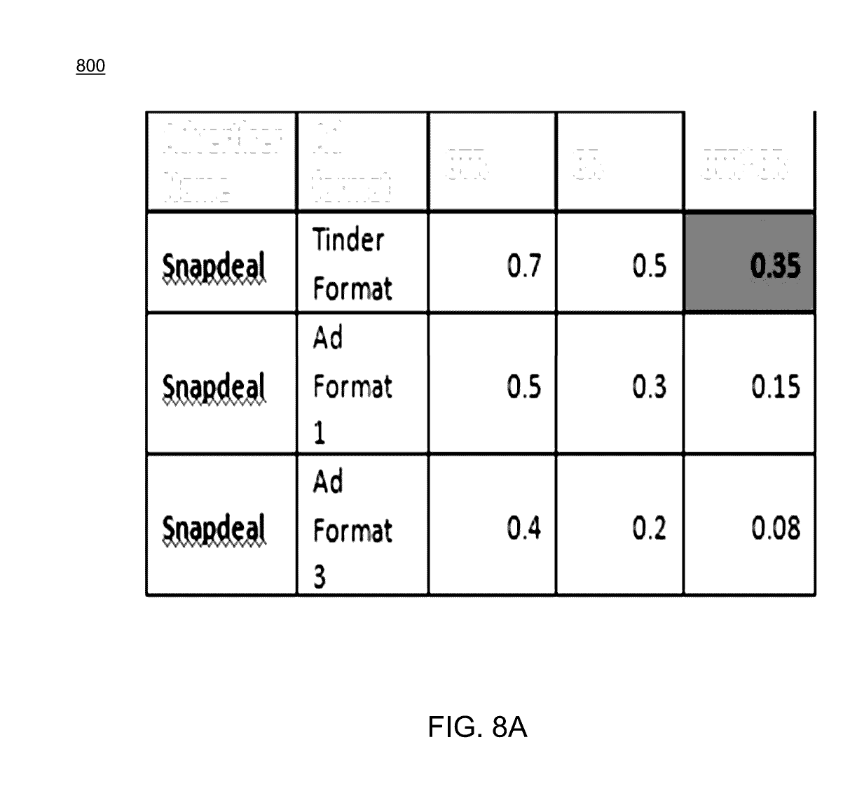

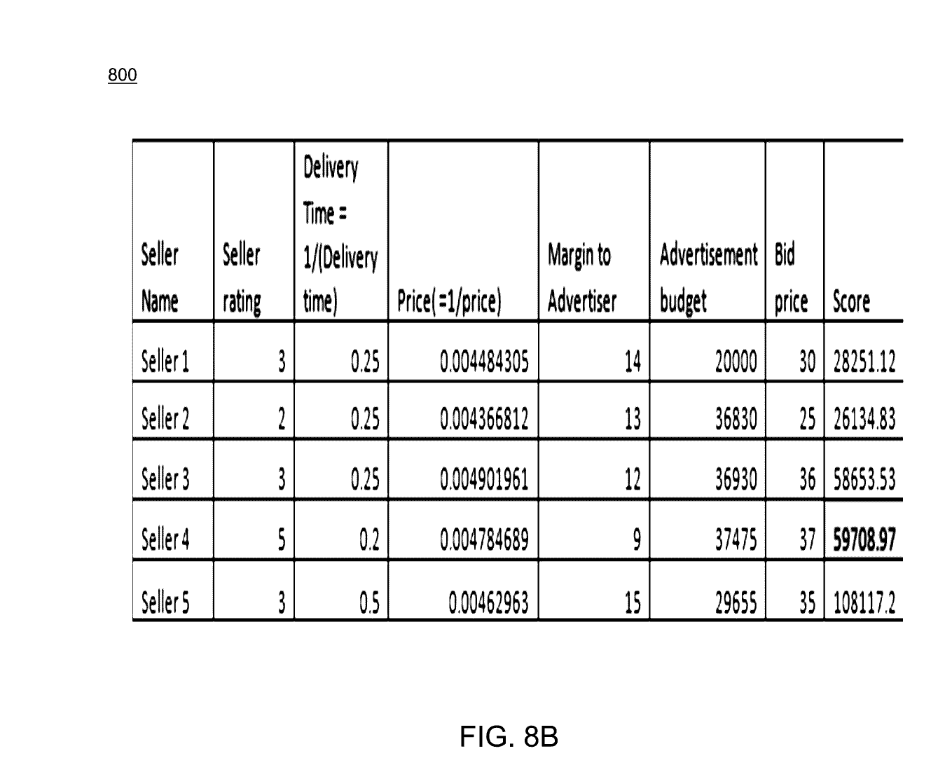

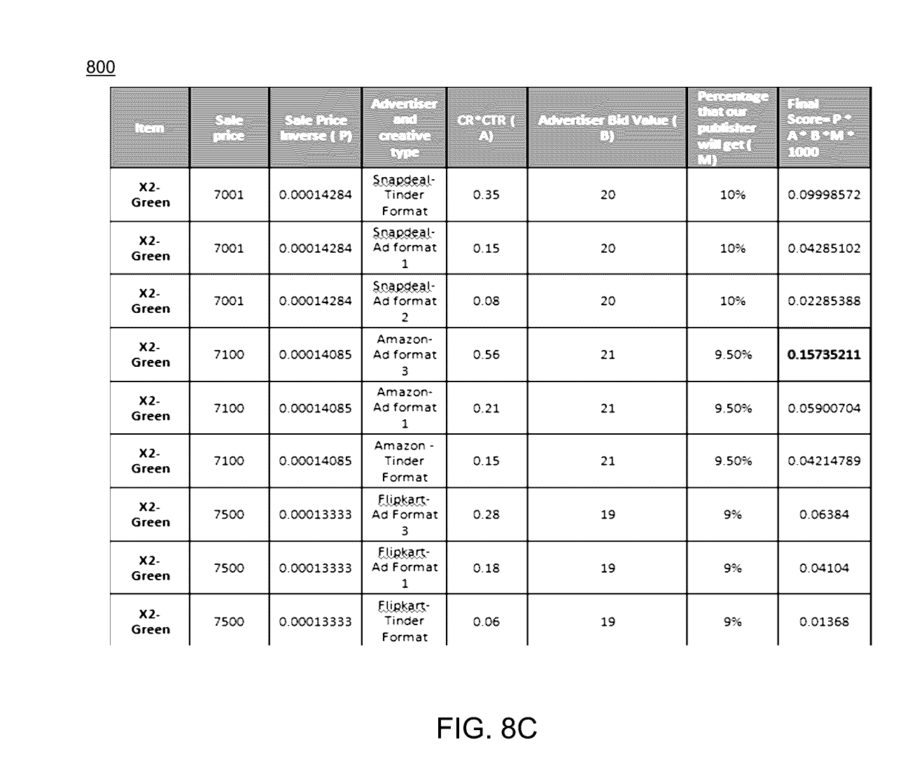

FIG. 8A, FIG. 8B and FIG. 8C illustrates an example snapshot 800 for taking a decision associated with the advertiser of the one or more advertisers for the recommending of the plurality of advertisements, in accordance with various embodiments of the present disclosure. FIG. 8A illustrates a snapshot 800 showing the decision associated with the displaying of the recommended product in the ad format having the highest value of the product of the click through rate and the click rate for the publisher (Snapdeal) not allowing the one or more third party product listing advertisement and having the single seller available for the recommended product. As shown in the FIG. 8A, the recommended product is displayed in the tinder format having the highest value of the product of the click through rate and the click rate of 0.35.

FIG. 8B illustrates a snapshot 800 showing the decision associated with the displaying of the recommended product for the publisher (Snapdeal) not allowing the one or more third party product listing advertisement and having the plurality of sellers available for the recommended product. As shown in the FIG. 8B, the plurality of sellers include seller 1, seller 2, seller 3, seller 4 and seller 5. The final score for each of the plurality of sellers is calculated based on the seller rating, the delivery time, the price of the recommended product, the margin to advertiser and the advertisement budget. In addition, a seller (seller 4) of the plurality of sellers having the highest final score (59708.97) is selected for displaying the advertisement associated with the recommended product.

FIG. 8C illustrates a snapshot 800 for showing the decision taken for the publisher of the one or more publishers 110 allowing the one or more third party product listing advertisement and having the plurality of advertisers for providing the advertisements for the corresponding recommended product (X2—green). As shown in the FIG. 8C, the final recommendation score is calculated for the recommended product (X2—green) based on the multiplication of the sale inverse price P, the value A of the product of the click through rate (CTR) and the click rate (CR), the advertiser bid value B and the percentage M that the publisher gets. The advertisement of the advertiser Amazon in the Ad format 3 is selected based on the final recommendation score of the advertiser Amazon in the Ad format 3 is the highest final recommendation score.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for hybrid recommendation of one or more products viewed by a user of one or more users on a publisher of one or more publishers through one or more advertisements, the computer-implemented method comprising:
collecting, with a processor, a first set of pre-defined attributes associated with the user of the one or more users viewing the one or more products on the publisher of the one or more publishers;
classifying, with the processor, the user of the one or more users in one or more clusters based on the first set of pre-defined attributes, wherein the one or more clusters being created based on a first set of parameters, wherein the classifying and clustering being done for identifying a cluster of the one or more clusters to which the user of the one or more users belongs, wherein the identifying being based on calculation of an average cluster centroid value for the user of the one or more users, wherein the one or more clusters being created for identifying one or more parameters for the clustering and wherein the clustering being done at a pre-defined intervals of time;
determining, with the processor, one or more characteristics associated with a product of the one or more products currently viewed by the user of the one or more users, wherein the determining of the one or more characteristics being based on the identification of the cluster of the one or more clusters;
gathering, with the processor, data associated with other one or more products similar to the product currently viewed by the user based on the determination of the one or more characteristics and the identification of the cluster of the one or more clusters, wherein the other one or more products depict similar characteristics to the one or more characteristics associated with the product of the one or more products currently viewed by the user and wherein the other one or more products belong to an identified cluster of the one or more clusters corresponding to the product of the one or more products currently viewed by the user;
computing, with the processor, a weighted average propensity to buy for the user of the one or more users, wherein the weighted average propensity to buy being computed for the product of the one or more products currently viewed by the user of the one or more users and the other one or more products similar to the product currently viewed by the user, wherein the weighted average propensity to buy being computed based on a second set of pre-defined attributes and a pre-defined criterion, wherein the pre-defined criterion being based on analyzing a past behavior of a set of users of the one or more users who have bought the product of the one or more products and the other one or more products and one or more actions taken corresponding to the product of the one or more products and the other one or more products; and
recommending, with the processor, the one or more advertisements associated with the product of the one or more products currently viewed by the user and the other one or more products having a highest weighted average propensity to buy.

2. The computer-implemented method as recited in claim 1, further comprising calculating, with the processor, a recommendation score for the product of the one or more products currently viewed by the user of the one or more users and the other one or more products, wherein the recommendation score being calculated based on multiplication of a similarity of the product currently viewed by the user and the other one or more products and the corresponding weighted average propensity to buy for the product currently viewed by the user and the other one or more products.

3. The computer-implemented method as recited in claim 2, wherein the recommendation being based on at least one of a seller rating, a price of the product of the one or more products and the other one or more products recommended to the user, click through rate and a seller bid for a particular ad format and publisher combination.

4. The computer-implemented method as recited in claim 1, wherein the first set of pre-defined attributes comprises at least one of an intent of the user, the one or more products liked by the user, the one or more products disliked by the user, age of the user, gender of the user, current location of the user, a type of device utilized by the user, current contextual behavior of the user and past behavior of the user.

5. The computer-implemented method as recited in claim 1, wherein the first set of parameters comprises at least one of a demography of the user, one or more details associated with the product of the one or more products and one or more attributes associated with the product of the one or more products.

6. The computer-implemented method as recited in claim 1, wherein the second set of pre-defined attributes corresponds to one or more types of events, wherein the one or more types of events comprises at least one of a duration of view by the user and the set of users for the product of the one or more products and the other one or more products, search performed by the user and the set of users for searching the product of the one or more products and the other one or more products, add to cart event, add to wish list event, a purchase event, checkout initiated event, product view and product reject event.

7. The computer-implemented method as recited in claim 6, further comprising assigning, with the processor, a value corresponding to each of the one or more types of events for the user and the set of users, wherein the value being assigned for determining a propensity to buy for the product of the one or more products currently viewed by the user and the other one or more products and wherein the value being highest for the purchase event and the value being lowest for the product reject event.

8. The computer-implemented method as recited in claim 1, wherein the one or more characteristics associated with the product of the one or more products comprises at least one of a type of the product viewed, a category of the product viewed, a name of the product viewed, an id of the product viewed, a brand name of the product viewed and one or more specifications of the product viewed by the user.

9. The computer-implemented method as recited in claim 1, further comprising updating, with the processor, the weighted average propensity to buy, the one or more clusters, the first set of pre-defined attributes, the first set of parameters, the second set of pre-defined attributes and the recommendation score, wherein the updating being performed at a pre-defined continuous intervals of time and wherein the updating being done for refining of recommendation algorithm.

10. The computer-implemented method as recited in claim 1, further comprising taking a decision, with the processor, associated with an advertiser of one or more advertisers whose advertisement of the plurality of advertisements corresponding to the recommended product of the one or more products and the other one or more products will be displayed to the user of the one or more users, wherein the decision being taken based on a condition specified by the publisher of the one or more publishers.

11. A computer-program product for hybrid recommendation of one or more products viewed by a user of one or more users on a publisher of one or more publishers through one or more advertisements, the computer-program product comprising:
a computer readable storage medium having a computer program stored thereon for performing the steps of:
collecting a first set of pre-defined attributes associated with the user of the one or more users viewing the one or more products on the publisher of the one or more publishers;
classifying the user of the one or more users in one or more clusters based on the first set of pre-defined attributes, wherein the one or more clusters being created based on a first set of parameters, wherein the classifying and clustering being done for identifying a cluster of the one or more clusters to which the user of the one or more users belongs, wherein the identifying being based on calculation of an average cluster centroid value for the user of the one or more users, wherein the one or more clusters being created for identifying one or more parameters for the clustering and wherein the clustering being done at a pre-defined intervals of time;
determining one or more characteristics associated with a product of the one or more products currently viewed by the user of the one or more users, wherein the determining of the one or more characteristics being based on the identification of the cluster of the one or more clusters;
gathering data associated with other one or more products similar to the product currently viewed by the user based on the determination of the one or more characteristics and the identification of the cluster of the one or more clusters, wherein the other one or more products depict similar characteristics to the one or more characteristics associated with the product of the one or more products currently viewed by the user and wherein the other one or more products belong to an identified cluster of the one or more clusters corresponding to the product of the one or more products currently viewed by the user;
computing a weighted average propensity to buy for the user of the one or more users, wherein the weighted average propensity to buy being computed for the product of the one or more products currently viewed by the user of the one or more users and the other one or more products similar to the product currently viewed by the user, wherein the weighted average propensity to buy being computed based on a second set of pre-defined attributes and a pre-defined criterion, wherein the pre-defined criterion being based on analyzing a past behavior of a set of users of the one or more users who have bought the product of the one or more products and the other one or more products and one or more actions taken corresponding to the product of the one or more products and the other one or more products; and
recommending the one or more advertisements associated with the product of the one or more products currently viewed by the user and the other one or more products having a highest weighted average propensity to buy.

12. The computer-program product as recited in claim 11, further comprising calculating a recommendation score for the product of the one or more products currently viewed by the user of the one or more users and the other one or more products, wherein the recommendation score being calculated based on multiplication of a similarity of the product currently viewed by the user and the other one or more products and the corresponding weighted average propensity to buy for the product currently viewed by the user and the other one or more products.

13. The computer-program product as recited in claim 11, wherein the first set of pre-defined attributes comprises at least one of an intent of the user, the one or more products liked by the user, the one or more products disliked by the user, age of the user, gender of the user, current location of the user, a type of device utilized by the user, current contextual behavior of the user and past behavior of the user.

14. A hybrid recommendation system for hybrid recommendation of one or more products viewed by a user of one or more users on a publisher of one or more publishers through one or more advertisements, the hybrid recommendation system comprising:
a collection module in a processor, the collection module being configured to collect a first set of pre-defined attributes associated with the user of the one or more users viewing the one or more products on the publisher of the one or more publishers;
a clustering module in the processor, the clustering module being configured to classify the user of the one or more users in one or more clusters based on the first set of pre-defined attributes, wherein the one or more clusters being created based on a first set of parameters, wherein the classifying and clustering being done for identifying a cluster of the one or more clusters to which the user of the one or more users belongs, wherein the identifying being based on calculation of an average cluster centroid value for the user of the one or more users, wherein the one or more clusters being created for identifying one or more parameters for the clustering and wherein the clustering being done at a pre-defined intervals of time;
a determination module in the processor, the determination module being configured to determine one or more characteristics associated with a product of the one or more products currently viewed by the user of the one or more users, wherein the determining of the one or more characteristics being based on the identification of the cluster of the one or more clusters;
a gathering module in the processor, the gathering module being configured to gather data associated with other one or more products similar to the product currently viewed by the user based on the determination of the one or more characteristics and the identification of the cluster of the one or more clusters, wherein the other one or more products depict similar characteristics to the one or more characteristics associated with the product of the one or more products currently viewed by the user and wherein the other one or more products belong to an identified cluster of the one or more clusters corresponding to the product of the one or more products currently viewed by the user;
a computational module in the processor, the computational module being configured to compute a weighted average propensity to buy for the user of the one or more users, wherein the weighted average propensity to buy being computed for the product of the one or more products currently viewed by the user of the one or more users and the other one or more products similar to the product currently viewed by the user, wherein the weighted average propensity to buy being computed based on a second set of pre-defined attributes and a pre-defined criterion, wherein the pre-defined criterion being based on analyzing a past behavior of a set of users of the one or more users who have bought the product of the one or more products and the other one or more products and one or more actions taken corresponding to the product of the one or more products and the other one or more products; and
a recommendation engine in the processor, the recommendation engine being configured to recommend the one or more advertisements associated with the product of the one or more products currently viewed by the user and the other one or more products having a highest weighted average propensity to buy.

15. The hybrid recommendation system as recited in claim 14, further comprising a scoring module in the processor, the scoring module being configured to calculate a recommendation score for the product of the one or more products currently viewed by the user of the one or more users and the other one or more products, wherein the recommendation score being calculated based on multiplication of a similarity of the product currently viewed by the user and the other one or more products and the corresponding weighted average propensity to buy for the product currently viewed by the user and the other one or more products.

16. The hybrid recommendation system as recited in claim 14, wherein the first set of pre-defined attributes comprises at least one of an intent of the user, the one or more products liked by the user, the one or more products disliked by the user, age of the user, gender of the user, current location of the user, a type of device utilized by the user, current contextual behavior of the user and past behavior of the user.

17. The hybrid recommendation system as recited in claim 14, wherein the second set of pre-defined attributes corresponds to one or more types of events, wherein the one or more types of events comprises at least one of a duration of view by the user and the set of users for the product of the one or more products and the other one or more products, search performed by the user and the set of users for searching the product of the one or more products and the other one or more products, add to cart event, add to wish list event, a purchase event, checkout initiated event, product view and product reject event.

18. The hybrid recommendation system as recited in claim 17, further comprising an assigning module in the processor, the assigning module being configured for assigning a value corresponding to each of the one or more types of events for the user and the set of users, wherein the value being assigned for determining a propensity to buy for the product of the one or more products currently viewed by the user and the other one or more products and wherein the value being highest for the purchase event and the value being lowest for the product reject event.

19. The hybrid recommendation system as recited in claim 14, further comprising an updation engine in the processor, the updation engine being configured to update the weighted average propensity to buy, the one or more clusters, the first set of pre-defined attributes, the first set of parameters, the second set of pre-defined attributes and the recommendation score, wherein the updation being performed at a pre-defined continuous intervals of time and wherein the updation being done for refining of recommendation algorithm.

20. The hybrid recommendation system as recited in claim 14, further comprising a decision module in the processor, the decision module being configured for deciding an advertiser of one or more advertisers whose advertisement of the plurality of advertisements corresponding to the recommended product of the one or more products and the other one or more products will be displayed to the user of the one or more users, wherein the decision being taken based on a condition specified by the publisher of the one or more publishers.
